(19) United States
(12) Patent Application Publication
(10) Pub. No.: US 2015/0229995 A1
(43) Pub. Date: Aug. 13, 2015

(54) SYSTEMS AND METHODS FOR PROVIDING CONTENT DISTRIBUTION INFORMATION AND VERIFICATION

(71) Applicant: VISIBLE WORLD, INC., New York, NY (US)

(72) Inventors: Seth HABERMAN, New York, NY (US); Claudio MARCUS, Andover, NH (US)

(21) Appl. No.: 14/617,722

(22) Filed: Feb. 9, 2015

Related U.S. Application Data
(60) Provisional application No. 61/936,947, filed on Feb. 7, 2014.

(51) Int. Cl. H04N 21/466; H04N 21/441; H04N 21/442; H04N 21/854; H04N 21/81

(52) U.S. Cl. CPC H04N 21/4667; H04N 21/854; H04N 21/812; H04N 21/44213; H04N 21/441

(57) ABSTRACT

Methods, systems, and computer-readable media for managing content presentation information associated with the distribution of content assets to content presentation devices are generally described. A presentation information management system may be configured to verify whether a content asset was presented via a content presentation device according to a distribution plan. In some embodiments, the management system may be configured to generate a content identifier for each content asset accessed by the management system and to receive presentation information when the content asset is presented through a content presentation device. The content identifier may be configured to allow the content asset to be recognized within the management system, such as at the content presentation device, when the content asset is presented at the content presentation device.

### CROSS REFERENCE TO RELATED APPLICATIONS

This application claims the benefit of U.S. Provisional Application No. 61/936,947 filed on Feb. 7, 2014, the contents of which are incorporated by reference in their entirety as if fully set forth herein.

### FIELD OF INVENTION

The described technology generally relates to providing information associated with the presentation of content and, more specifically, to verifying the presentation of content according to a distribution plan.

### BACKGROUND

Certain content developers, such as advertisers and online content creators, have not been able to receive accurate and timely information about when and how their content was presented to users. Accordingly, these content developers have not been able to verify that their content was broadcast to users according to their contracts with content distributors. For example, television advertisers are not able to determine what content distributors are counting as impressions when broadcasters and media agencies attest that advertisements ran at a particular time. In addition, advertisers have complained about the lag time between when their television advertisements supposedly aired and the post-run analyses for verifying that their advertisements ran at the times and during the programs as required. It can take weeks for such post-run analysis reports, usually generated by the company selling the ads or a third-party processor, to be received by the advertisers. As such, discrepancies often cannot be be addressed until after an advertising campaign has concluded.

Audience-based advertisement buying is a new model for programmatic buying and selling that may present new opportunities for content developers, but may also increase issues with accurate and timely reporting of content impressions. Currently, most non-digital media, particularly television content, is packaged, sold and bought based on content and context. While it is possible to scale advertising campaigns across different media, such as buying advertising opportunities on a website, in a printed publication (e.g., a magazine) and on television, programmatic buying and selling can add scale and improve audience targeting through audience-based advertising in which an advertiser may “buy” or target specific audiences, defined by a core set of data, across many different media irrespective of content or context.

Through audience-based advertising, media agencies are able to use their trading desks and demand-side platforms (DSPs) to create bids for media inventory to “audience-buy” based on scientific, real-time programmatic technology. The growth of audience-based advertising buying is being driven by, among other things, the opportunity to use data-driven audience-targeting solutions to improve the coordination of advertising across multiple media categories, such as digital and television advertising campaigns.

Audience-based buying raises new concerns relating to advertisement verification as advertisers and agencies buying the related television audiences do not have visibility into the actual advertisement inventory being used to execute their campaigns. For instance, when using audience-based television buying, instead of buying individual television advertisement placements, advertisers and/or agencies are buying a certain number of impressions for a defined target audience. However, the companies doing the television audience-based selling do not provide visibility into the specific television advertisement units associated with the audience-based television buys. As such, audience-based buying currently leaves advertisers and agencies without any way to independently verify whether, when, and where their advertisement were distributed or any means to estimate the potential audience impressions of such advertisements.

Accordingly, content developers would benefit from a system capable of providing accurate and timely information relating to the presentation and audience impressions of their content.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a content distribution verification system may include a processor and a non-transitory, computer-readable storage medium in operable communication with the processor. The computer-readable storage medium contains one or more programming instructions that, when executed, cause the processor to access at least one content asset associated with a distribution plan, generate at least one content identifier for the at least one content asset, the at least one content identifier being configured to identify the at least one content asset responsive to the at least one content asset being presented on at least one content presentation device, receive presentation information responsive to the at least one content asset presented by the at least one content presentation device being recognized based on the at least one content identifier, and generate a content presentation report based on the presentation information, the content presentation report being configured to verify whether the at least one content asset was presented according to the distribution plan.

In an embodiment, a computer-implemented method for verifying the distribution of content may include, by a processor, accessing at least one content asset associated with a distribution plan, generating at least one content identifier for the at least one content asset, the at least one content identifier being configured to identify the at least one content asset responsive to the at least one content asset being presented on at least one content presentation device, receiving presentation information responsive to the at least one content asset presented by the at least one content presentation device being recognized based on the at least one content identifier, generating a content presentation report based on the presentation information, the content presentation report being configured to verify whether the at least one content asset was presented according to the distribution plan.

In an embodiment, a computer-readable storage medium may have computer-readable program code configured to verify the distribution of content. The computer-readable program code may include computer-readable program code configured to access at least one content asset associated with a distribution plan, generate at least one content identifier for the at least one content asset, the at least one content identifier being configured to identify the at least one content asset responsive to the at least one content asset being presented on at least one content presentation device, receive presentation information responsive to the at least one content asset presented by the at least one content presentation device being recognized based on the at least one content identifier, and computer-readable program code configured to generate a content presentation report based on the presentation information, the content presentation report being configured to verify whether the at least one content asset was presented according to the distribution plan.

### BRIEF DESCRIPTION OF THE DRAWINGS

The above and other objects of the present invention will become more readily apparent from the following detailed description taken in connection with the accompanying drawings.

FIG. 1 depicts an illustrative content presentation information management system according to some embodiments.

FIG. 2 depicts an illustrative content presentation information management system according to some embodiments.

FIG. 3 depicts a flow diagram for an illustrative method of managing content presentation information according to some embodiments.

FIG. 4 illustrates various embodiments of a computing device for implementing the various methods and processes described herein.

### DETAILED DESCRIPTION

The described technology generally relates to systems, methods, and computer readable media for managing content presentation information associated with the distribution of content assets to content presentation devices. In some embodiments, a presentation information management system (the “system” or “management system”) may be configured to verify whether a content asset was presented via a content presentation device (for instance, an “impression”) according to a distribution plan. In some embodiments, the management system may be configured to generate a content identifier for each content asset accessed by the management system and to receive presentation information when the content asset is presented through a content presentation device. The content identifier may be configured to allow the content asset to be recognized within the management system, such as at the content presentation device, when the content asset is presented (for example, viewed, downloaded, accessed, played-back, recorded, streamed, or the like) at the content presentation device. In some embodiments, the system may include or otherwise use an automated content recognition (ACR) system to recognize content assets. A content identifier may be configured to provide a unique identifier of the content, such as a fingerprint, watermark, alphanumeric code or string, or other identification device. In some embodiments, the content identifier may be generated using the content, such as generating a unique fingerprint or alphanumeric code based on the video and/or audio content. In some embodiments, the content identifier may include a unique alphanumeric identifier assigned to the content.

A content asset (or “content”) may generally include any type of data, information, media, or the like that may be expressed through a medium. Illustrative mediums may include audio and visual mediums such as television, radio, and broadcast, cable, satellite, and/or network (e.g., Internet) forms thereof. Examples of content may include, but are not limited to, video, audio, movies, video games, television and radio programs, commercials, websites, images, photographs, text, electronic or digital documents, haptic or tactile sensations, information feeds, streaming media, social media, social networks, and/or combinations thereof. In some embodiments, content may include an advertisement, such as a television advertisement or an online advertisement including, without limitation, website advertisements, Internet advertisements, search engine marketing (SEM), social media marketing, and mobile device advertising.

A content presentation device is generally any device now known to those having ordinary skill in the art or developed in the future that is capable of presenting content to a viewer or other type of content consumer. Non-limiting examples of content presentation devices include televisions, smart televisions, laptops, personal digital assistants (PDAs), tablet computing devices, smartphones, personal computers (PCs), display monitors or terminals, radios, audio devices, speakers, headphones, haptic devices, electronic reading devices (“e-readers”), light emitting diode (LED) devices, organic LED (OLED) devices, wearable screens, set-top-boxes, satellite receivers, video-on-demand (VOD) receivers, content receivers (e.g., Apple TV® manufactured by Apple Inc. of Cupertino, Calif., United States; Roku® manufactured by Roku, Inc. of Saratoga, Calif., United States), digital video recorders (DVRs), personal video recorders (PVRs), hard drives, flash drives, storage servers, digital video disc (DVD) devices, Blu-Ray™ devices, or the like.

Presentation information may generally include information relating to the presentation of content at a content presentation device. Non-limiting examples of presentation information may include time, date, geographic information, content identifier, content, content presentation device information (e.g., device identifier, hardware information, device type, owner or subscriber information, network information, device activity, for example, indicating likelihood of actual user impression, or the like), network information (e.g., transmission networks, subscriber networks, broadcast networks or channels), playback information (e.g., fast-forwarding, recording, whether entire content asset was viewed, or the like), or the like.

A distribution plan may include any type of schedule and/or plan configured to specify the distribution of content, such as an advertising campaign for advertising content. In some embodiments, the distribution plan may include an audience-based advertising buying campaign. In some embodiments, the management system may be configured to verify whether a content asset has been distributed, viewed, accessed, or otherwise presented to an audience according to the distribution plan.

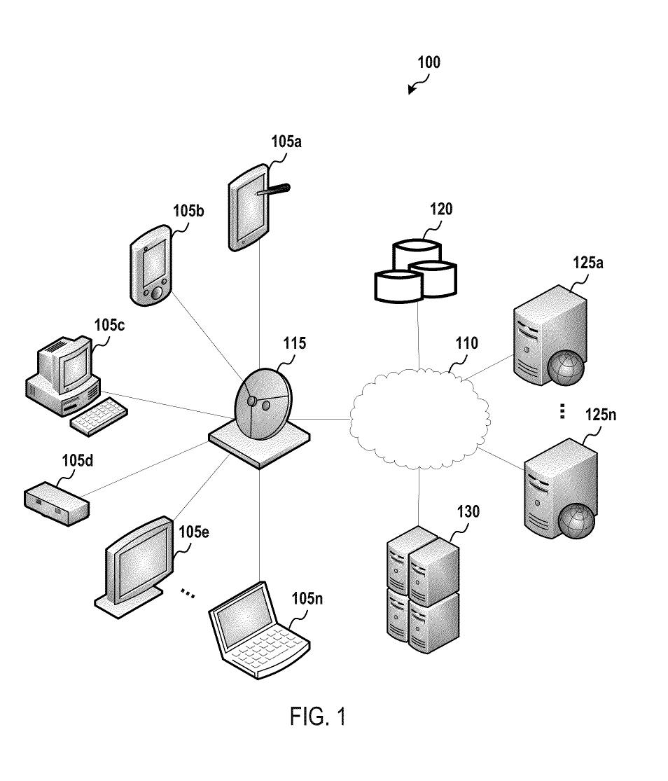

FIG. 1 depicts an illustrative management system according to some embodiments. As shown in FIG. 1, a management system 100 may include content developers 125a-n configured to develop content for distribution by a service provider 115. A content developer 125a-n may include any type of content developer known to those having ordinary skill in the art, such as an advertiser, an advertising agency, a television studio or broadcast network, a radio channel, a website provider, a VOD service, a content storage and delivery service, or the like. A service provider 115 may access content from the content providers 125a-n over a network, 110 such as a cable or satellite network or a communications network, such as the Internet. The service provider 115 may include any type entity or structure capable of providing content to a content presentation device 105a-n. For instance, the service provider 115 may include a television broadcast network, a cable television network, a satellite television network, an internet service provider (ISP), a computing device advertising network, a media distribution network, a cloud computing network, a local area network (LAN), a wide area network (WAN), a terrestrial network, a mobile network, and/or any combination thereof.

The content presentation devices 105a-n may include any type of device capable of receiving and/or presenting content to a viewer or other content consumer. Non-limiting examples of content presentation devices include televisions, smart televisions (or other Internet-or network-enabled televisions), laptops, PDAs, table computing devices, smartphones, PCs, display monitors or terminals, radios, audio devices, speakers, headphones, haptic devices, electronic reading devices, LED devices, OLED devices, wearable screens, set-top-boxes, satellite receivers, VOD receivers, content receivers

In some embodiments, the service provider 115 may include a network for transmitting content directly from the content provider 125a-n to the content presentation devices 105a-n. For instance, the service provider 115 may include a network and associated technology for a television production studio to provide content directly to content presentation devices 105a-n. In another instance, the service provider 115 may include a content access application and associated hardware and software for allowing a user to access content from various content providers 125a-n. Illustrative content access applications include Netflix® and Hulu®. In some embodiments, the content providers 125a-n may communicate directly with the content presentation devices 105a-n, for example, through the network 110.

The content presentation system 100 may include and/or have access to one or more data stores 120. The data stores 120 may be configured to store content and or information that may be used by the content presentation devices 105a-n, service providers 115, and/or content providers 125a-n for the creation, transmission, and/or presentation of the content. In some embodiments, the data stores 120 may at least partially include data from third parties. For instance, the data stores 120 may include information associated with the content assets, distribution plans, content identifiers (for example, a content fingerprint library), audience targeting information (for instance, demographic information, viewer preference information, historical content access information), the number and types of content presentation devices 105a-n receiving content through the service provider 115 and/or the network 110, content presentation device 105a-n operating systems, software, firmware, and/or hardware, viewer or other content consumer and/or consumer device profiles, or the like.

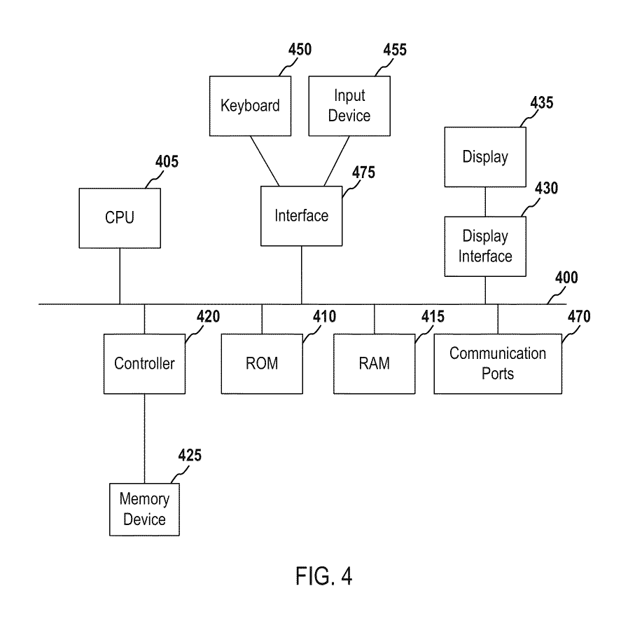

As shown in FIG. 1, the management system 100 may include one or more server logic devices 130, which may generally include a processor, a non-transitory memory or other storage device for housing programming instructions, data or information regarding one or more applications, and other hardware, including, for example, the central processing unit (CPU) 405, read only memory (ROM) 410, random access memory (RAM) 415, communication ports 440, controller 420, and/or memory device 425 depicted in FIG. 4 and described below in reference thereto.

In some embodiments, the programming instructions may include a presentation information management application (the “management application”) configured to, among other things, receive or otherwise access content assets from the content developers 125a-n, generate content identifiers, detect or otherwise recognize when a content asset has been presented at a content presentation device 105a-n, generate a message when the content asset has been presented at a content presentation device, generate presentation information responsive to the content asset being presented at the presentation device, generate a content presentation report based on the presentation information, and verify whether a content asset has been distributed according to a distribution plan based on the presentation information, and/or any combination thereof. In some embodiments, the management application may include or may otherwise access an ACR application, hardware, or system (an “ACR system”) to detect or otherwise recognize when a content asset has been presented at a content presentation device 105a-n.

The server logic devices 130 may be in operable communication with the content presentation devices 105a-n, the service provider 115, and/or content providers 125a-n. In some embodiments, the management application may be accessible through various platforms, such as a client application, a web-based application, over the Internet, and/or a mobile application (for example, a “mobile app” or “app”). According to some embodiments, the management application and/or client versions thereof may be configured to operate on and/or be otherwise accessible to each presentation device 105a-n and/or to operate on a server computing device accessible to presentation devices over a network, such as the Internet. All or some of the files, data and/or processes (for example, medical research information, analysis processes, or the like) used for accessing and/or the processing of the content identifiers and/or the presentation information may be stored locally on each presentation device 105a-n, stored in a central location, such as server logic devices 130, and/or accessible over a network.

In some embodiments, the management application and/or the ACR system may be operated by the content developers 125a-n, the content distributor 115, or some combination thereof. In some embodiments, the management application and/or the ACR system may be operated by an independent system or entity in communication with the content developers 125a-n and/or the content distributors 115.

In some embodiments, the management application may be configured to compare the presentation information with a distribution plan, such as a content distribution campaign, an advertising campaign, a programming schedule, an audience target campaign (such as an audience-based advertising campaign). For example, the management application may be configured to compare the actual impressions indicated based on the presentation information with the target impressions required or otherwise specified by the distribution plan. The presentation information may include, among other things, information relating to the particular users and/or user demographics of viewers who watched, downloaded, viewed, played-back, streamed, or otherwise accessed one or more content assets. As such, the management application may determine how the actual content viewers compare with the target viewers specified in a distribution plan. Such verification of the distribution plan may be reported using various techniques, such as percentages, hits/misses, total impressions, or the like.

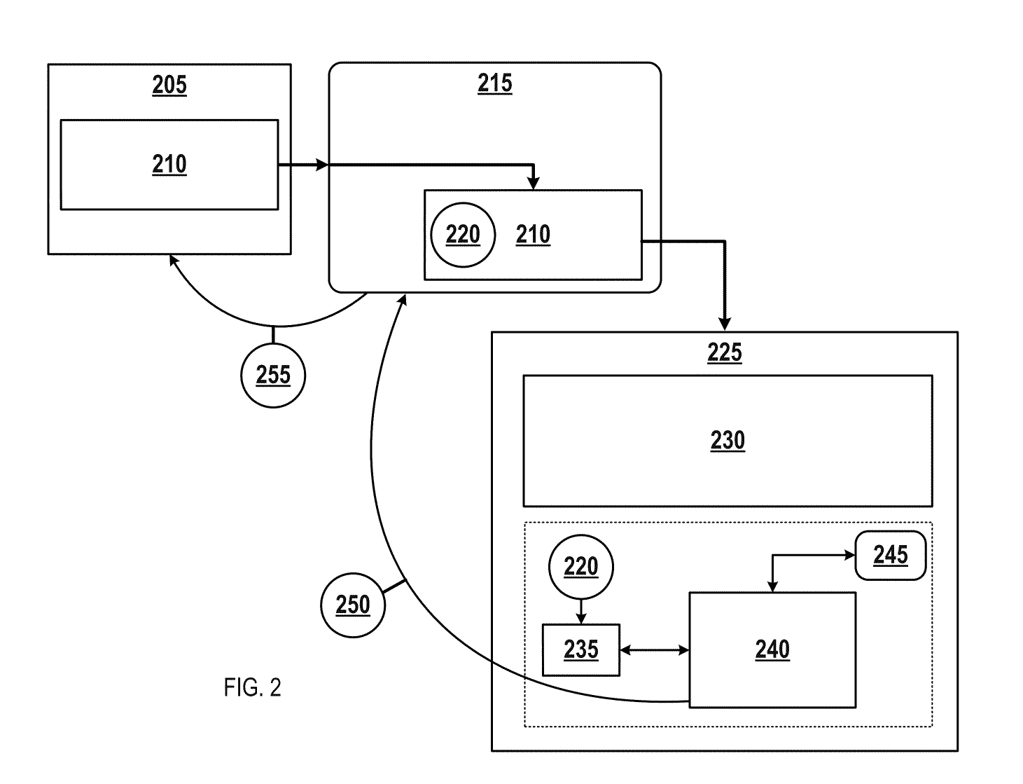

FIG. 2 depicts an illustrative management system according to some embodiments. As shown in FIG. 2, a content developer 205 may develop a content asset 210, such as a television advertisement. The advertisement 210 may be provided to a management system 215 that may generate a content identifier 220 for the advertisement. The content identifier 220 may be embedded or otherwise associated with the advertisement 210 using methods known to those having ordinary skill in the art, such as for MPEG-2 and/or MPEG-4 content. In some embodiments, the content identifier 220 may be stored in a data store (a data base or content identifier library) and not embedded or otherwise transmitted with the advertisement. In such an embodiment, the advertisement 210 may be analyzed when presented at the device and the data store searched to determine whether a content identifier matching the advertisement is stored therein.

In some embodiments, the advertisement 210 may be broadcast, transmitted, streamed, or otherwise distributed to a content presentation device 225, such as a television. The advertisement 210 may be distributed directly through the management system 215 or through a content distributor (not shown) operably coupled to the management system. The television 225 may present the advertisement 210 on a display element 230, such as a television screen.

A management application 240 may be operating on or may otherwise access the content being presented by the television 225, either directly or through one or more networks feeding content to the television 225. The management application 240 may include or otherwise access a content recognition module 235 configured to monitor, analyze, screen, or otherwise process content presented through the television for content identifiers associated therewith. In some embodiments, the content recognition module 235 may include or may otherwise access a system an ACR system.

In some embodiments, the management application 240 may determine when the advertisement 210 with the content identifier 220 has been played on the television 225 by detecting the content identifier. In some embodiments, the management application 240 may determine when the advertisement 210 associated with the content identifier 220 has been played on the television 225 by searching a content identifier library for a matching content identifier.

Although FIG. 2 depicts the management application 240 as operating on the television 225, embodiments are not so limited as the management application may operate on any device capable of monitoring or detecting content presented on the television 225 or transmitted thereto. In some embodiments, the management application 240 may detect content with a content identifier as it is being transmitted to a content presentation device, such as the television 225.

When the management application 240, through the content recognition module 235, detects the content identifier 220, the management application may access and/or generate presentation information 245 associated with the presentation of the advertisement 210 on the television 225. A presentation information message 250 may be transmitted to the content distributor 215. In some embodiments, the management application 240 and/or the content distributor 215 may use the presentation information 245 to generate a presentation report 255 that may be used by the content developer 205 to view information relating to the presentation of the content 210, including whether the content was distributed and/or presented (for example, viewer impressions) according to a distribution plan.

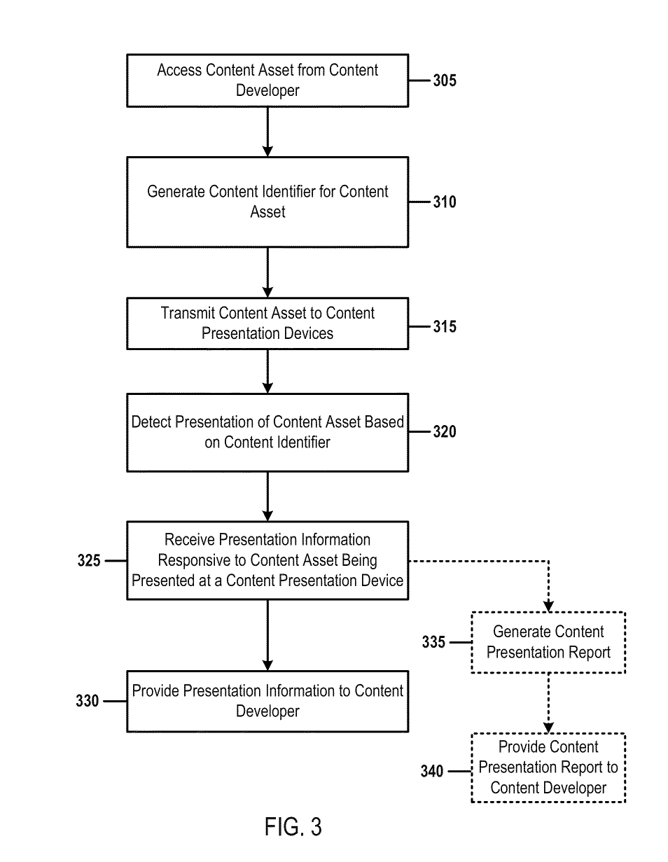

FIG. 3 depicts a flow diagram for an illustrative method of managing content presentation information according to some embodiments that may be performed by the management system, such as through one or more server logic devices, arranged in accordance with at least some embodiments described herein. Example methods may include one or more operations, functions or actions as illustrated by one or more of blocks 305, 310, 315, 320, 325, 330, 335, and/or 340. The operations described in blocks 305-340 may also be stored as computer-executable instructions in a computer-readable medium such the memory elements 410, 415, and 425 depicted in FIG. 4. Although illustrated as discrete blocks, various blocks may be divided into additional blocks, combined into fewer blocks, or eliminated, depending on the desired implementation. The operations described in blocks 305-340 may be performed by a content developer, a content distributor, a content provider, a content presentation device, a network system, a broadcast network, or any combination thereof.

As shown in FIG. 3, the management system may access 305 content from a content developer. For example, an advertiser or agency may provide an advertisement or a sample for each unique advertisement being used in conjunction with a distribution plan, such as an advertising campaign, including an audience-based advertisement buy. The management system may generate 310 a content identifier and embed the content identifier in the content and/or related content assets. For instance, unique television advertisements may be processed to generate unique audio and/or video fingerprints and/or watermarks that may be used in connection with an ACR system or other content recognition system deployed at a network, geographic, and/or specific device level (for instance, an Internet-connected smart television). The content asset may be transmitted 315 to the content presentation devices and/or a network providing content thereto.

The content may be detected 320 based on the content identifier. In some embodiments, ACR may be used at least in part to detect when the content asset associated with a distribution plan, such as a specific audience-based television buy, is presented (or “airs”). Detection 320 of the presentation or airing of the content asset also allows for the receiving 325 of presentation information, such as the identification of any related distribution networks, presentation times, geography, device information, and any other information relating associated with the presentation. In some embodiments, such as when content recognition (for instance, ACR) is conducted at the content presentation device level (for instance, with an ACR-enabled smart television), detection across a sufficient sample of devices may make it possible to accurately estimate specific geographies, times, and other presentation information where the content assets are presented and, in addition, the level of audience impressions relating thereto. The presentation information may be provided 330 to the content developer, such as an advertiser or agency. In this manner, the content developer may have access to accurate information concerning the presentation of their content in real-time or substantially real-time.

In some embodiments, optionally, a content presentation report 335 may be generated based on the presentation information. For example, the presentation information may be analyzed or otherwise subjected to analytics processes to provide context for the detection 320 of the content presentation (for instance, the airing of a television advertisement). In another example, the presentation information may be analyzed in view of a distribution plan to confirm whether detection 320 was part of the distribution plan, such as an audience-based advertising buy. In a further example, using the presentation information derived from the presentation detection 320, reporting for audience-based advertising buys can include the placement of detected advertisement insertions (for instance, a presentation network, a presentation time, and a presentation geography), estimates of audience impressions, as well as estimates of audience reach and distribution frequency of exposure to the advertisement(s) and/or campaign. In addition, by combining such measures with other third party databases, additional information can be derived and presented, such as the estimated cost of each ad insertion, impression estimates for specific audience types (e.g. affluent households with kids), or the like. These measures and reporting can be provided both during and after the course of a campaign. The content presentation report may be provided 340 to the content developer.

In an audience-based television buy embodiment, where the same television advertisement(s) may also be used for campaigns that are not part of an audience-based television buy, it possible to distinguish detections associated with other campaigns using the same television advertisement(s) by having the advertiser and/or agency provide the specific advertisement insertion logs associated with the campaign(s). Matching the advertisement insertions associated with these insertions to the ACR-enabled advertisement detections, enables the system to make sure the analysis and related reporting is focused exclusively on the insertions associated with the audience-based television buy.

While the embodiments described herein detail certain broadcast and transmission mechanisms, one skilled in the art would recognize that any means of media content transmission are fully within the scope of the invention. Further, while the embodiments described herein detail the use of the display device itself or set-top-boxes, one skilled in the art should recognize that the invention may be implemented using a variety of hardware and software that may reside internally to the display device, externally or both.

FIG. 4 depicts a block diagram of exemplary internal hardware that may be used to contain or implement the various computer processes and systems as discussed above. A bus 400 serves as the main information highway interconnecting the other illustrated components of the hardware. CPU 405 is the central processing unit of the system, performing calculations and logic operations required to execute a program. CPU 405 is an exemplary processing device, computing device or processor as such terms are used within this disclosure. Read only memory (ROM) 430 and random access memory (RAM) 435 constitute exemplary memory devices.

A controller 420 interfaces with one or more optional memory devices 425 via the system bus 400. These memory devices 425 may include, for example, an external or internal DVD drive, a CD ROM drive, a hard drive, flash memory, a USB drive or the like. As indicated previously, these various drives and controllers are optional devices. Additionally, the memory devices 425 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with the determination, configuration, transmission, decoding, or the like of the presentation settings as described above may be stored in the ROM 430 and/or the RAM 435. Optionally, the program instructions may be stored on a tangible computer-readable medium such as a compact disk, a digital disk, flash memory, a memory card, a USB drive, an optical disc storage medium, such as a Blu-Ray™ disc, and/or other recording medium.

An optional display interface 430 can permit information from the bus 400 to be displayed on the display 435 in audio, visual, graphic or alphanumeric format. Communication with external devices may occur using various communication ports 440. An exemplary communication port 440 may be attached to a communications network, such as the Internet or a local area network.

The hardware may also include an interface 445 which allows for receipt of data from input devices such as a keyboard 450 or other input device 455 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A content distribution verification system, comprising:
a processor; and
a non-transitory, computer-readable storage medium in operable communication with the processor, wherein the computer-readable storage medium contains one or more programming instructions that, when executed, cause the processor to:
access at least one content asset associated with a distribution plan,
generate at least one content identifier for the at least one content asset, the at least one content identifier being configured to identify the at least one content asset responsive to the at least one content asset being presented on at least one content presentation device,
receive presentation information responsive to the at least one content asset presented by the at least one content presentation device being recognized based on the at least one content identifier, and
generate a content presentation report based on the presentation information, the content presentation report being configured to verify whether the at least one content asset was presented according to the distribution plan.

2. The system of claim 1, wherein the at least one content asset comprises a television advertisement.

3. The system of claim 1, wherein the at least one content presentation device comprises at least one of a television and a smart television.

4. The system of claim 1, wherein the at least one content asset is recognized using automated content recognition.

5. The system of claim 1, wherein the distribution plan comprises an advertising campaign.

6. The system of claim 1, wherein the distribution plan comprises an audience-based advertising buy campaign.

7. The system of claim 1, wherein the presentation information comprises a presentation time, a presentation geography, and a presentation network.

8. The system of claim 1, wherein the presentation report comprises an estimate of audience impressions for the at least one content asset.

9. A computer-implemented method for verifying the distribution of content, the method comprising, by a processor:
accessing at least one content asset associated with a distribution plan;
generating at least one content identifier for the at least one content asset, the at least one content identifier being configured to identify the at least one content asset responsive to the at least one content asset being presented on at least one content presentation device;
receiving presentation information responsive to the at least one content asset presented by the at least one content presentation device being recognized based on the at least one content identifier; and
generating a content presentation report based on the presentation information, the content presentation report being configured to verify whether the at least one content asset was presented according to the distribution plan.

10. The computer-implemented method of claim 9, wherein the at least one content asset comprises a television advertisement.

11. The computer-implemented method of claim 9, wherein the at least one content presentation device comprises at least one of a television and a smart television.

12. The computer-implemented method of claim 9, wherein the at least one content asset is recognized using automated content recognition.

13. The computer-implemented method of claim 9, wherein the distribution plan comprises an advertising campaign.

14. The computer-implemented method of claim 9, wherein the distribution plan comprises an audience-based advertising buy campaign.

15. The computer-implemented method of claim 9, wherein the presentation information comprises a presentation time, a presentation geography, and a presentation network.

16. The computer-implemented method of claim 9, wherein the presentation report comprises an estimate of audience impressions for the at least one content asset.

17. A computer-readable storage medium having computer-readable program code configured to verify the distribution of content, the computer-readable program code comprising:
computer-readable program code configured to access at least one content asset associated with a distribution plan;
computer-readable program code configured to generate at least one content identifier for the at least one content asset, the at least one content identifier being configured to identify the at least one content asset responsive to the at least one content asset being presented on at least one content presentation device;
computer-readable program code configured to receive presentation information responsive to the at least one content asset presented by the at least one content presentation device being recognized based on the at least one content identifier; and
computer-readable program code configured to generate a content presentation report based on the presentation information, the content presentation report being configured to verify whether the at least one content asset was presented according to the distribution plan.

18. The computer-readable storage medium of claim 17, wherein the at least one content asset comprises a television advertisement.

19. The computer-readable storage medium of claim 17, wherein the at least one content asset is recognized using automated content recognition.

20. The computer-readable storage medium of claim 17, wherein the distribution plan comprises an audience-based advertising buy campaign.
